(19) United States
(12) Patent Application Publication
(10) Pub. No.: US 2002/0167137 A1
(43) Pub. Date: Nov. 14, 2002

(54) SHOCK-ABSORBING CONNECTING MEMBER OF A GOLF TROLLEY

(76) Inventor: Liz Lin, San Diego, CA (US)

Correspondence Address: ROSENBERG, KLEIN & LEE, 3458 ELLICOTT CENTER DRIVE-SUITE 101, ELLICOTT CITY, MD, 21043, US

(21) Appl. No.: 09/851,165

(22) Filed: May 9, 2001

(51) Int. Cl. B62B 1/18

(52) U.S. Cl. 280/47.24

(57) ABSTRACT

A shock absorbing connecting member is connected to a main support rod of a golf trolley. The shock absorbing connecting member includes a front part and a rear part, the front part is secured to the main support rod; the rear part is movably fitted to the front part with elastic members being disposed between same and the front part. The front part has guide rods passed through guide holes of the rear part. The wheel support rods of the wheels of the golf trolley are connected to the rear part form upper ends such that the elastic members can absorb shock on the wheels when the golf trolley moves along a rough ground.

### BACKGROUND OF THE INVENTION

The present invention relates to a golf trolley, and particularly to one which has a connecting member capable of absorbing the shock caused because of collision of the golf trolley wheels with holes or stones on the ground.

Referring to FIG. 5, a conventional golf trolley has a main support rod 10, a supporting member 101, a locating member 102, a connecting member 103, wheel support rods 104, wheels 105, locating rods 106 and a handle 107.

The supporting member 101 and the handle 107 are connected to a lower end and an upper end of the main support rod 10 respectively. The locating member 102 is connected to an intermediate portion of the main support rod 10. The connecting member 103 is connected to the main support rod 10 under the locating member 102. The wheel support rods 104 are each connected to the connecting member 103 form one end, and connected to a respective one of the wheels 105 from the other end. The locating rods 106 are pivoted to the locating member 102 from one end, and pivoted to the wheel support rods 104 from the other end.

A golf bag can be supported by the supporting member 101, and located by the locating member 102 in order to be moved around by means of the golf trolley.

However, the golf trolley is not provided with a shock absorber so a user pulling same on a golf course is likely to have sore hands because of the shock caused when the golf trolley jolts along a rough area or collides with stones.

### SUMMARY OF THE INVENTION

Therefore, it is a main object of the present invention to provide a shock absorbing member to a golf trolley such that the user can pull the golf trolley relatively comfortably even on a rough area of the golf course.

The shock absorbing member of a golf trolley of the present invention includes a front part and a rear part. The front part is secured to a main support rod of the golf trolley.

The rear part is movably fitted to the front part with elastic members disposed in between. The front part has guide rods sticking out from a rear side to pass through guide holes of the rear part, and has bolts passing through connecting holes to screw into connecting holes of the rear part to prevent the front part and the rear part from falling apart.

The elastic members are confined from two ends by locating recesses of both the front and the rear part such that same can' t fall out.

The wheel support rods of the wheels of the golf trolley are connected to the left and the right sides of the rear part of the shock absorbing member such that shock on the wheels can be absorbed by the elastic member.

### BRIEF DESCRIPTION OF THE DRAWINGS

This invention will be better understood by referring to the accompanying drawings, wherein:

FIG. 1 is an exploded perspective view of the shock absorbing connecting member of a golf trolley according to the present invention.

FIG. 2 is a side view of the shock absorbing connecting member of a golf trolley according to the present invention.

FIG. 3 is a side view of a golf trolley with the shock absorbing connecting member in FIG. 2 in action.

FIG. 4 is a side view of the shock absorbing connecting member in FIG. 2.

FIG. 5 is a perspective view of the conventional golf trolley in the Background.

### DETAILED DESCRIPTION OF THE PREFERRED EMBODIMENT

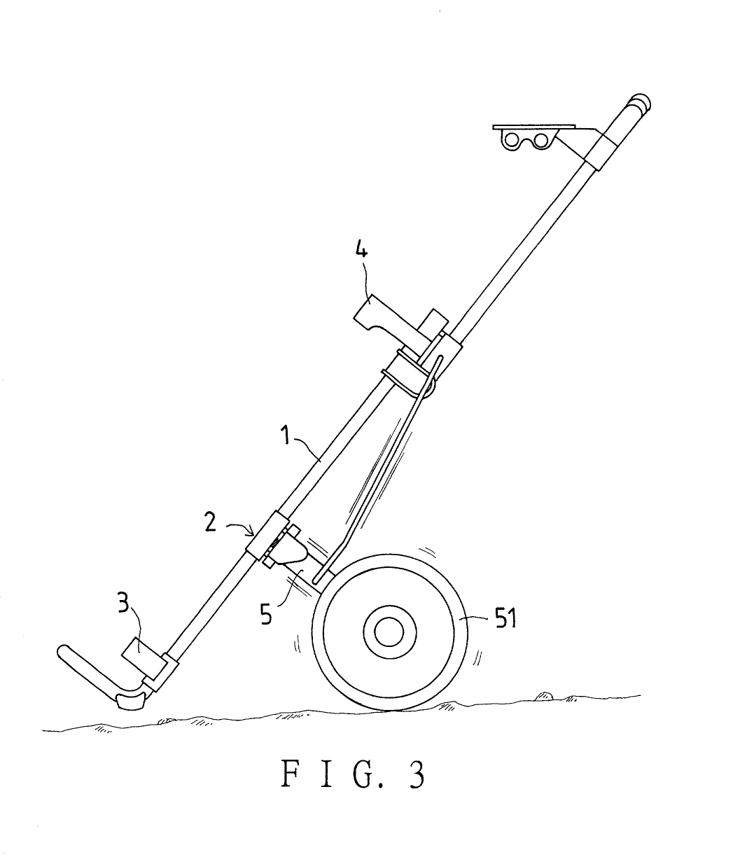

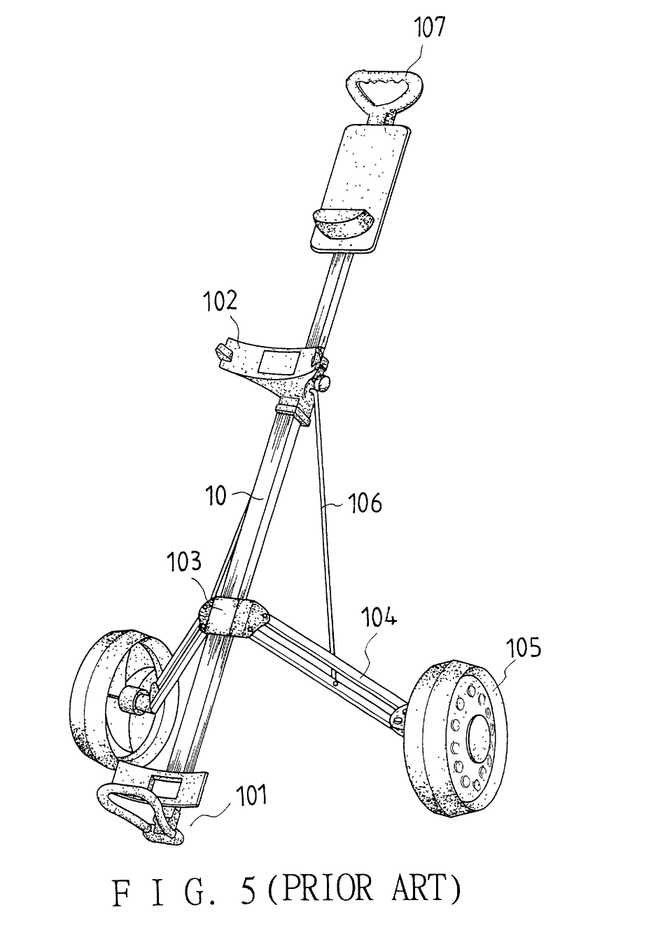

Referring to FIG. 3, a golf trolley of the present invention includes a main support rod 1, a shock absorbing connecting member 2, a support member 3, wheel support rods 5, a locating member 4, wheels 51 and a handle (not numbered).

The handle and the supporting member 3 are connected to an upper end and a lower end of the main support rod 1 respectively. The locating member 4 is connected to the main support rod 1.

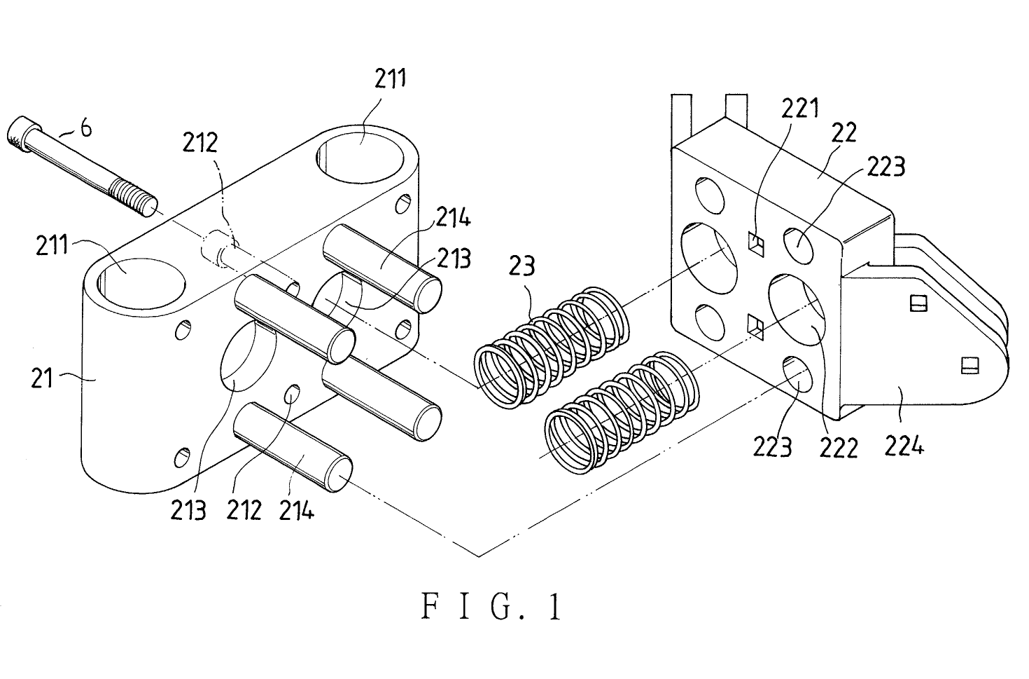

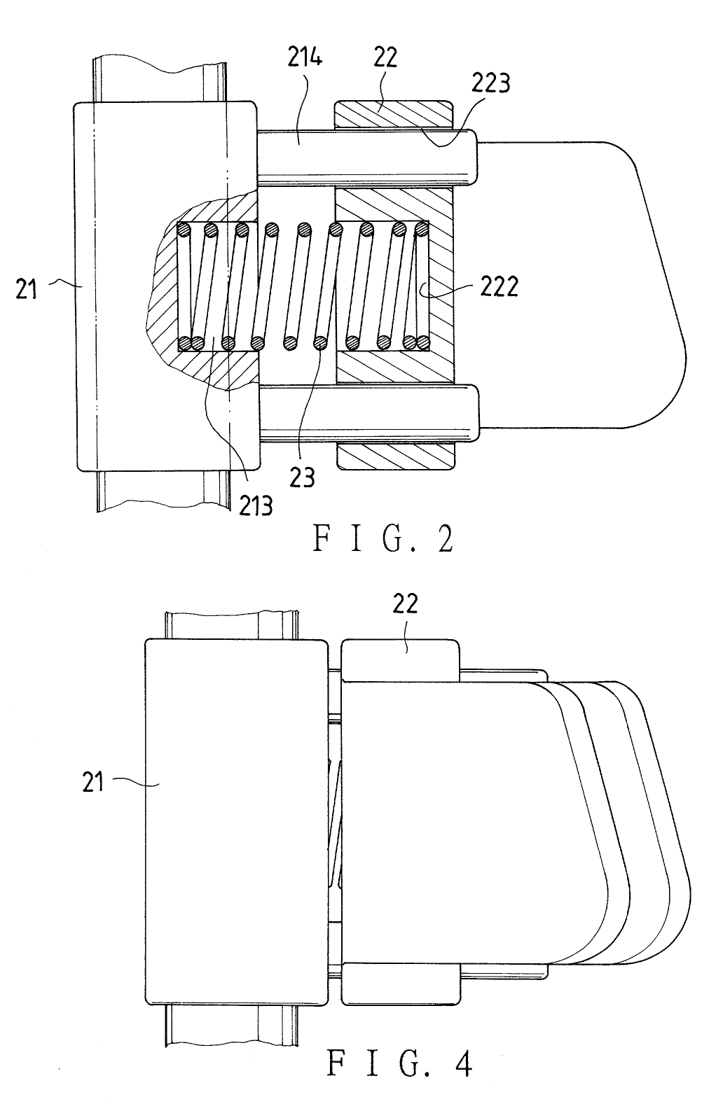

Referring to FIGS. 1 and 3, the shock absorbing connecting member 2 includes a front part 21, a rear part 22 and two elastic members 23.

The front part 21 has two longitudinal holes 211, four guide rods 214 sticking out from a rear side, two locating recesses 213 and several connecting holes 212. The front part 21 is connected to an intermediate portion of the main support rod I with the longitudinal holes 211 being each connected to a respective one of two middle rod parts (not shown) of the main support rods 1.

The rear part 22 of the connecting member 2 has four guide holes 223, two locating recesses 222 on a front side, connecting holes 221, and side protruding parts 224 on a left and a right sides. The rear part 22 is movably fitted to the front part 21 with the guide rods 214 of the front part 21 being each passed through one of the guide holes 223 of the rear part 22, and with the elastic members 23 being confined between the locating recesses 213 of the front part 21 and the locating recesses 222 of the rear part 22; bolts 6 are passed through the connecting holes 212 of the front part 21, and screwed into the connecting holes 221 of the rear part 22 to prevent the parts 21 and 22 form falling apart

The wheel support rods 5 are connected to the side protruding parts 224 of the rear part 22, and the wheels 51 are connected to lower ends of the wheel support rods 5.

A golf bag is disposed on the supporting member 3, and secured to the locating member 4 in order to be moved around on the golf course.

When the golf trolley moves along on a rough ground or the wheels 51 collide with stones, the elastic members 23 disposed between the front and the rear parts 21 and 22 can absorb the shocks.

From the above description, the golf trolley of the present invention can be known to have a desirable feature that a golf player using same is less likely to have sore hands than using a golf trolley without a shock absorber.

What is claimed is:

1. A shock absorbing connecting member of a golf trolley, comprising
a front part, said front part being connected to a main support rod of said golf trolley;
a rear part, said rear part being movably fitted to said front part with elastic members disposed between same and said front part; said rear part being connected to wheel support rods having lower ends connected to wheels of said golf trolley for said elastic members to absorb shock on said wheels when said golf trolley moves along a rough ground.

2. The shock absorbing connecting member of a golf trolley as claimed in claim 1, wherein said front part has two longitudinal holes each being connected to a respective rod part of said main support rod, and has a plurality of guide rods sticking out on a rear side each passed through a corresponding one of guide holes of said rear part and has bolts passing through connecting holes thereof to screw into connecting holes of said rear part to prevent said front and said rear parts from falling apart; said elastic members being located from two ends by means of locating recesses on said rear side of said front part and a front side of said rear part.
